(19) United States
(12) Patent Application Publication
(10) Pub. No.: US 2009/0207979 A1
(43) Pub. Date: Aug. 20, 2009

(54) SYSTEM AND METHOD FOR RECORDING AND EVALUATING COMMUNICATION

(76) Inventor: Charles Mark Russell, Roswell, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/143,560

(22) Filed: Jun. 20, 2008

Related U.S. Application Data
(63) Continuation-in-part of application No. 12/033,783, filed on Feb. 19, 2008.

(51) Int. Cl. H04M 1/64

(52) U.S. Cl. 379/85

(57) ABSTRACT

A system and method for recording and evaluating communication including a computer program product operable to allow users to search for and locate one or more selected target user(s) and operable to provide access to feedback from one or more verified user(s) having recorded one or more communication with the selected target user(s), including recorded verbal interactions between the verified users and the selected target user(s). Additional subjective information, rating, comment, or the like may be provided to supplement the objective information, wherein the objective information may allow a user to put the subjective information into context

### RELATED APPLICATION

The present Non-Provisional U.S. Utility Patent Application is a Continuation-in-Part of, and hereby claims priority to, and the full benefit of, Non-Provisional U.S. Utility patent application Ser. No. 12/033,783, filed Feb. 19, 2008, entitled “System and Method for Publicizing Business Services,” hereby incorporated by reference.

### TECHNICAL FIELD

The present invention relates generally to communication systems and methods, and, more particularly, to systems and methods for recording and evaluating communication.

### BACKGROUND OF THE INVENTION

In many situations, including business, social, and civic situations, an individual's credibility, reputation for a characteristic, such as honesty, within a relevant community may be crucial for the individual's ability to achieve a desired result, at least where interaction with other individuals is required or beneficial for achieving the result. In order to facilitate proliferation of information for use in assessing such and individual's credibility or reputation, at least in a business context, many systems have been developed and implemented to allow customers to provide feedback for an individual and/or an associated business. The goal of such systems is typically to allow other users of the systems, particularly prospective customers, to investigate the reputation of individuals and/or businesses for use in making better decisions regarding selection of a provider for goods and/or services. Unfortunately, however, such systems fail to provide prospective customers with an ability to judge the veracity, accuracy, or appropriateness of another individual's assessment, such as in the form of an anecdote, opinion, or rating, associated with a given provider. This problem is exacerbated where the anecdote, opinion, or rating is provided via a computer network-based system and the prospective customer: 1) has no prior acquaintance with the individual providing the anecdote, opinion, or rating, 2) has no option to ask questions or gain additional information to expose any bias that may affect the anecdote, opinion or rating, and 3) has no access to verified objective evidence of the provider's conduct.

For example, a given provider's conduct may be acceptable to a first customer, whereafter the first customer may provide a positive opinion and/or a high rating of the provider, but such conduct or service may be unacceptable to a second customer. If the second customer relies solely on the opinion and/or rating of the first customer, the second customer may likewise become a customer of the provider, only to ultimately be disappointed. The converse situation may also occur, wherein an extremely sensitive customer may denounce a provider for a product or a service that is acceptable to the majority of customers. Nonetheless, prospective customers may be turned away by a negative opinion or low rating provided by the disgruntled, overly-sensitive customer.

Furthermore, currently available systems and methods for providing individuals of a given community with experiential opinions and/or ratings allow for manipulation by unscrupulous users of the systems. Specifically, users may artificially inflate their own rating by submitting numerous positive reviews for themselves through dummy accounts, via their friends, or the like. Additionally, such unscrupulous providers may attempt to artificially reduce the ratings of other users, especially when such other users are their competitors, via negative reviews or opinions of such other users. Thus, the benefit to the community of users is reduced due to an inability or hesitance to rely on the reviews and/or due to reliance on biased reviews provided by unscrupulous users or their agents.

The value of an anecdote, opinion, rating, or other subjective information, such as the kind that may be provided in a review or to justify a rating, may also be affected by simple misunderstandings. For example, after a conversation between a business and a customer, one or both parties may be confused about what the other said. Such confusion often leads to unnecessary dissatisfaction with the relationship. Accordingly, inappropriate or undeserved negative opinions or ratings of the business and/or the customer may result.

Finally, there are no similar systems available that are adapted to provide similar information for social or civic environments. Perhaps due to the inherent innacuracies, whether intentionally or unintentionally created, social networking communities, dating communities, and the like, have not provided their users with a peer rating or review system. The advantages of such a rating and/or review system for social, civic, or other non-commercial environments are similar to analogous systems adapted for business or commercial use, but have not yet been realized due to obvious flaws of such commercial systems. Nonetheless, a system that could provide reliable ratings and/or reviews of users as individuals and/or as a group, may allow other users to obtain valuable information about users with whom they may begin a relationship.

Thus, it is clear that there is an unmet need for a system and method for evaluating reputation that provides accurate, unbiased, and verifiable information to users seeking to locate reputable or recommended individuals or groups of individuals, that reduces inaccurate reviews or opinions based on confusion, and that allows users to increase or decrease reliance on a selected review, including any anecdotal information, opinion, or rating, based on such unbiased and verifiable information.

### BRIEF SUMMARY OF THE INVENTION

Briefly described, in a preferred embodiment, the present invention overcomes the above-mentioned disadvantages and meets the recognized need for such a system and method by providing a computer network-based system and method for recording and evaluating communication including a computer program product operable to allow users to search for and locate one or more selected target user(s) and operable to provide access to feedback from one or more verified user(s) having recorded one or more communication with the selected target user(s), including recorded verbal interactions between the verified users and the selected target user(s).

More specifically, the computer program product provides access to a database of user information and a search tool accessible by users operable to allow users to search for and to locate one or more selected target user(s). The computer program product may include an Internet-based phone book or the like to facilitate easy, efficient, and effective location of selected target user(s). The search tool may provide users with reviews, anecdotes, opinions, ratings, and/or the like, associated with a selected target user. Additionally, the search tool is operable to provide users with access to one or more previously-recorded audio, video, and/or text interaction(s) between the selected target user and another verified user of the system with whom the selected target user previously interacted. Users may then base a decision regarding whether to associate with or interact with the selected target user on an opinion formed at least in part from one or more previously-recorded, authentic communications, taking into account the user's own preferences, whereby quality of selection may be improved.

The previously-recorded interaction(s) may be limited to only those interactions conducted through the system, whereby the validity and/or accuracy of the recordings of the interactions may be ensured. Thus, the computer program product preferably further provides a communication feature operable to allow registered users to initiate a recorded interaction with a selected target user. For example, and as discussed in greater detail below, a prospective customer, a voter, or any other individual may initiate a recorded interaction with a service provider, a political candidate, or other selected individual or organization, in order document statements, assertions, opinions, or impressions provided by the selected target user during the interaction. Completed recordings of an interaction between a verified user and a selected target user are automatically stored and associated with an account of the verified user. The verified user may subsequently publish the recording, included in redacted form to ensure privacy for the verified user. Such publication may be made by making the recorded interaction accessible via one or more of a listing associated with the selected target user in the directory, a review or feedback webpage associated with the selected target user, a blog-style discussion or posting forum, a webpage associated with the verified user's account, by calling a telephone number, by email, or the like.

Accordingly, one feature and advantage of the present system and method is the ability to enable convenient recording, storage, and publication of interactions between users of the system for accountability and for use by other users in decision making.

Another feature and advantage of the present system and method is the ability to motivate users to avoid embarrassing, unacceptable, or inappropriate conduct during interactions, thereby improving the overall level of user satisfaction with communications conducted via the system.

Yet another feature of and advantage of the present system and method is the ability to avoid confusion regarding the content of interactions between users by enabling review of recorded interactions.

These and other features and advantages of the present system and method will become more apparent to those ordinarily skilled in the art after reading the following Detailed Description of the Invention and Claims in light of the accompanying drawing Figures.

### BRIEF DESCRIPTION OF THE DRAWINGS

Accordingly, the present claimed invention will be understood best through consideration of, and with reference to, the following drawings, viewed in conjunction with the Detailed Description of the Invention referring thereto, in which like reference numbers throughout the various drawings designate like structure, and in which:

FIG. 1 is a diagram of a system for recording and evaluating communication according to an exemplary embodiment of the present invention;

FIG. 2 is an illustration of an interface for account creation of the system of FIG. 1;

FIG. 3 is an illustration of a directory interface of the system of FIG. 1;

FIG. 4 is an illustration of an interface for publicizing a user of the system of FIG. 1;

FIG. 5 is an illustration of an interface for managing an account of the system of FIG. 1;

FIG. 6 is an illustration of an interface of the system of FIG. 1 for editing content associated with an account;

FIG. 7 is an illustration of an interface for publicizing a plurality of users of the system of FIG. 1; and

FIG. 8 is an illustration of an interface for publicizing users of the system of FIG. 1.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the drawings, specific terminology is employed for the sake of clarity. The invention, however, is not intended to be limited to the specific terminology so selected, and it is to be understood that each specific element includes all technical equivalents that operate in a similar manner to accomplish a similar purpose.

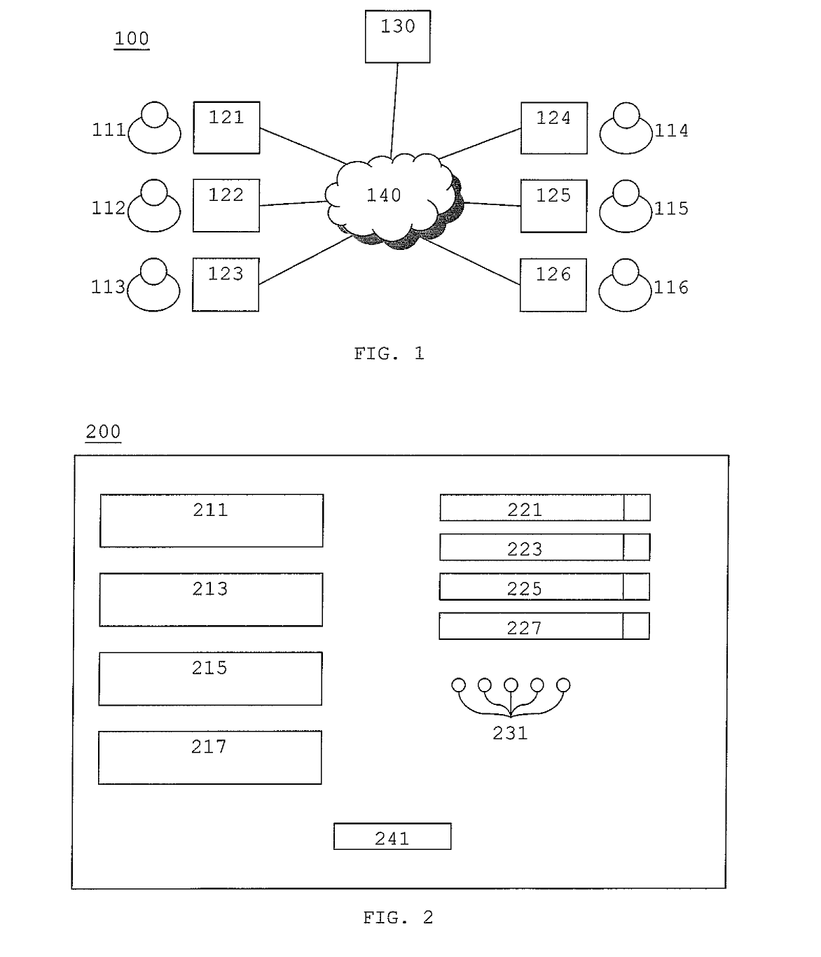

In that form of the preferred embodiment of system of the present disclosure chosen for purposes of illustration, FIG. 1 shows system 100 including users 111-116, respectively associated user interface devices 121-126, and host 130, all connected via network 140. As will be understood by those ordinarily skilled in the art, each of users 111-116 may be an individual, an association or organization, or other entity, and may or may not have previously registered or created an account. As will be understood by those ordinarily skilled in the art after reading the following disclosure, users 111-116 may use system 100 to record and evaluate communication for any suitable purpose. Particularly, however, system 100 is preferably adapted to accommodate one or more community of users, such as a plurality of users having a common interest, objective, trade, or the like, a marketplace for goods and/or services, or the like.

Each of user interface devices 121-126 preferably allows a respective associated one of users 111-116 to access host 130 and/or other devices connected, directly or indirectly, to network 140. Accordingly, each of user interface devices 121-126 may be formed as a computer, a telephone (whether cellular or otherwise), a radio device, a satellite device, or other communication device adapted to output at least one of an audio output and a graphic output (whether text, photo, video, or the like) and adapted to communicate with host 130 and/or one or more other user interface device. Host 130 is preferably formed as one or more server computers and is operable to communicate with each of user interface devices 121-126 via one or more similar or analogous communication device(s). Accordingly, network 140 may be formed as a local or wide area network, such as the Internet, including one or more wired or wireless communication components, such as optical components, copper wire components, radio components, satellite components, and other communication network equipment. The selection and configuration of each of user interface devices 121-126, host 130, and network 140 is preferably limited only as required to enable some or all of the functionality described below.

In an exemplary embodiment, host 130 may be accessed by a user, such as user 111, via a respective associated user interface device, such as user interface device 121. Upon accessing host 130, identification information, such as a username and password, may be required from user 111 for comparison with identification information of registered users. If user 111 has not yet registered, interface 200, depicted in FIG. 2, may be provided to user 111 via user interface device 121 in the form of a webpage, a client computer program, or the like. User 111 may create an account by providing required and/or requested information via one or more of data entry fields 211-217, drop-down menus 221-227, and radio buttons 231. Such required and/or requested information preferably includes a telephone number, email address, name, and physical address of user 111, and may further include a birth date, social security number, service provider names, password, PIN code, and service provider account numbers of user 111, or the like. After user 111 has completed providing required and/or requested information via manipulation of interface 200, user 111 may submit the information provided by activation of element 241, such as a button, or the like.

After receiving and processing such user-provided information, such as by creating an account and associating the information with the account, host 130 may verify some or all of the information. For example, host 130 may transmit an email to the email address provided by user 111 containing a link. Activation of the link by user 111 may cause host 130 to initiate a telephone call to a telephone number, IP address, or the like, provided by user 111 during the account creation process, or the like, including analog, digital, cellular, satellite, and land-line telephone calls or telephone calls placed over a computer network, whereby the phone number provided by user 111 may be verified. User 111 may then be required to enter verification information to verify that the phone number provided is associated with user 111, such as information contained in the email, such as in the form of a Captcha or other information not readable by a machine, or in the form of a PIN number or other user-provided information or code. Once the user's email address, phone number, and/or other information has been verified, the account associated with the user may be activated by host 130, whereafter user 111 may use system 100 to initiate recorded communication with one or more selected target user.

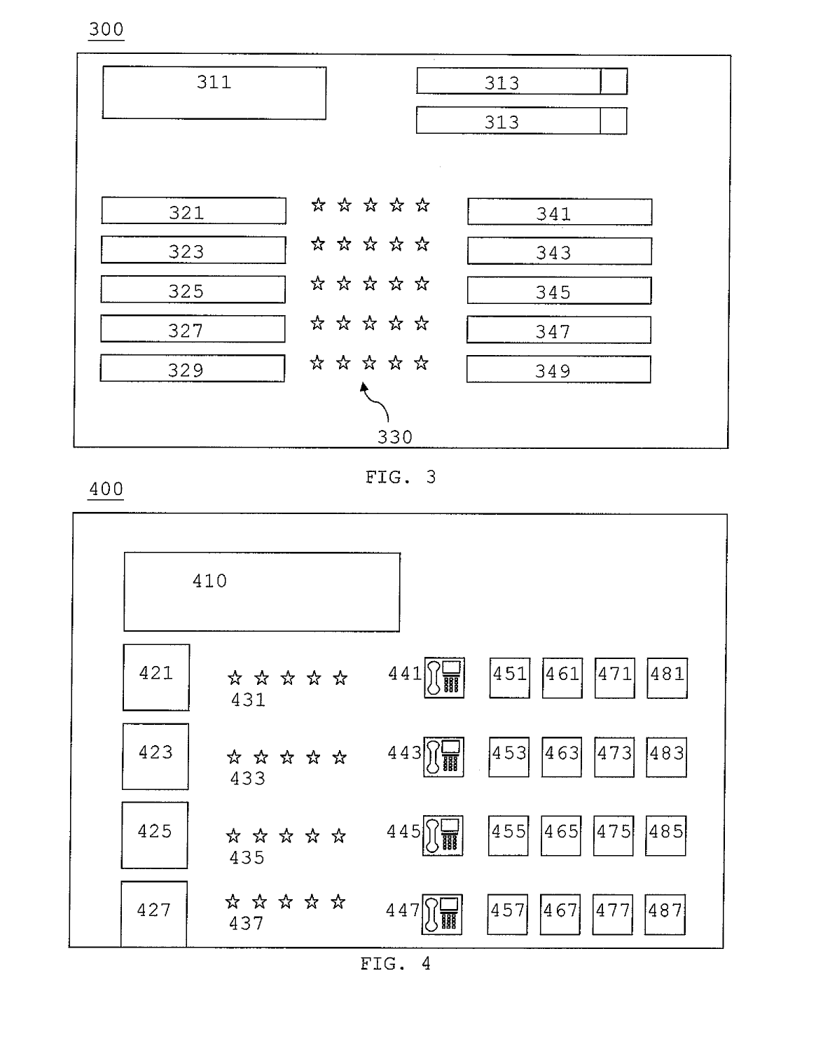

If user 111 is a registered user, then user 111 may access host 130 via user terminal 121 after verification of user-supplied identification information. Alternatively, if user 111 is not a registered user, but nonetheless wants to access system 100, user 111 may log on as a guest, wherein access to some but preferably not all features is permitted. In either case, user 111 may access a directory of system 100 via interface 300, as depicted in FIG. 3, such as a directory in the form of one or more database(s) stored on a storage medium of host 130. Maintenance of the directory on host 130 allows an operator of system 100 to ensure the veracity and accuracy of information contained therein, thereby enabling users to rely on such information. In use, user 111 may search for one or more target user to facilitate a desired objective. For example, user 111 may enter a keyword into entry box 311 of interface 300 and submit the keyword to host 130. Alternatively, or additionally, user 111 may select keywords or categories from drop-down menus 313. The keywords and/or categories may include criteria related to commercial interactions, social interaction, civic interactions, or other search criteria, as will be understood by those ordinarily skilled in the art. Preferably, one or more search criteria associated with a selected community of users. Thus, user 111 may search for a specific target user, one or more target user(s) meeting selected criteria, or may easily browse for a target user, as desired.

Regardless of how user 111 provides search criteria, host 130 may then provide a result, or a list of results, generated in response to the user-provided search criteria. A list of results may include names 321-329 of individual users and/or organizations, such as users 114, 115, 116, respectively, among others, having a characteristic or information matching the user-provided search criteria. Host 130 may further provide respective associated rating indications 330, such as an indication of an average rating provided by registered users of system 100, such as users 112, 113, among others, who are verified users having previous interactions or communication with users 114, 115, and 116, and other users listed by names 321-329. Furthermore, additional information associated with each of names 321-329 may be provided in fields 341-349, respectively. For example, an indication may be provided informing user 111 whether certain additional information is available for an associated one of names 321-329, such as an indication of whether system 100 includes one or more associated recorded interaction with a verified user that is available for review, and/or whether other documentary evidence, such as recorded interactions between a respective users 114-116, among others, and other verified users of system 100, is(are) available for review that may establish information about the respective one of users 114-116, among others. More specifically, field 341 may include an indication that a recorded interaction between user 114, such as a provider of goods and/or services, and user 112, such as a customer of user 114, is available for review, and/or that a recorded interaction between user 114, or another customer of user 114, and user 115, an insurance provider for user 114, is available to prove that user 114 maintains such insurance. As will be understood by those skilled in the art, many alternative facts, or the like, may be established via recorded interactions maintained by host 130. For example, system 100 may be used to establish licensure, qualification, endorsement, or the like, or to provide evidence of personal traits or characteristics, opinions, or the like.

Thus, user 111 may review various information associated with one or more selected target user(s), such as one or more of users 114-116, among others, for use in selecting a service provider with whom to do business, finding suitable companions, or any other purpose desired. For additional information, user 111 may activate a link, or other means, to access additional and/or specific information pertaining to any of users 114-116, among others, associated with names 321-329 and/or fields 341-349. For example, activating a link associated with name 321 may cause interface 400, as depicted in FIG. 4, associated with user 114 to be provided to user 111. Interface 400 preferably includes an indication that interface 400 is associated with user 114, such as via information displayed in area 410. Additionally, interface 400 preferably includes posted recorded interactions 421-427 between user 114 and a respective registered user of system 100 who has previously interacted with user 114. User 111 may access and review one or more of selected recorded interactions 421-427 to obtain objective evidence of the nature and quality of such recorded interactions.

The user may then use such objective evidence to evaluate user-provided rating information provided by the respective registered user of system 100, such as a rating displayed as stars 431-437 as well as commentary or anecdotal evidence of the nature and quality of the communication or interaction between the selected target user and the respective verified user. The commentary or anecdotal evidence may be provided in fields 451, 461, 471, and 481. For example, if user 111 determines, through independent assessment, that the nature and quality of interaction or communication evidenced by recorded interaction 421 is acceptable, user 111 may accordingly reduce a weight given to, or completely ignore, an associated low rating evidenced by stars 431 and/or negative commentary or anecdotal evaluations provided by the associated verified user in fields 451, 461, 471, and 481. Alternatively, user 111 may increase a weight given to an associated high rating evidenced by stars 431 and/or positive commentary or anecdotal evaluations provided by the associated verified user in fields 451, 461, 471, and 481. Additional and/or alternative types of evaluations, commentary, assessment, or the like, may be included in fields 451-487, such as discussion board thread style responses or posts, with or without attachment or inclusion of additional objective and/or subjective evidence of communication or interaction associated with user 114. Such additional and/or alternative information may be included in interface 400 and/or in additional interfaces, such as a discussion board interface, a blog-style interface, or the like.

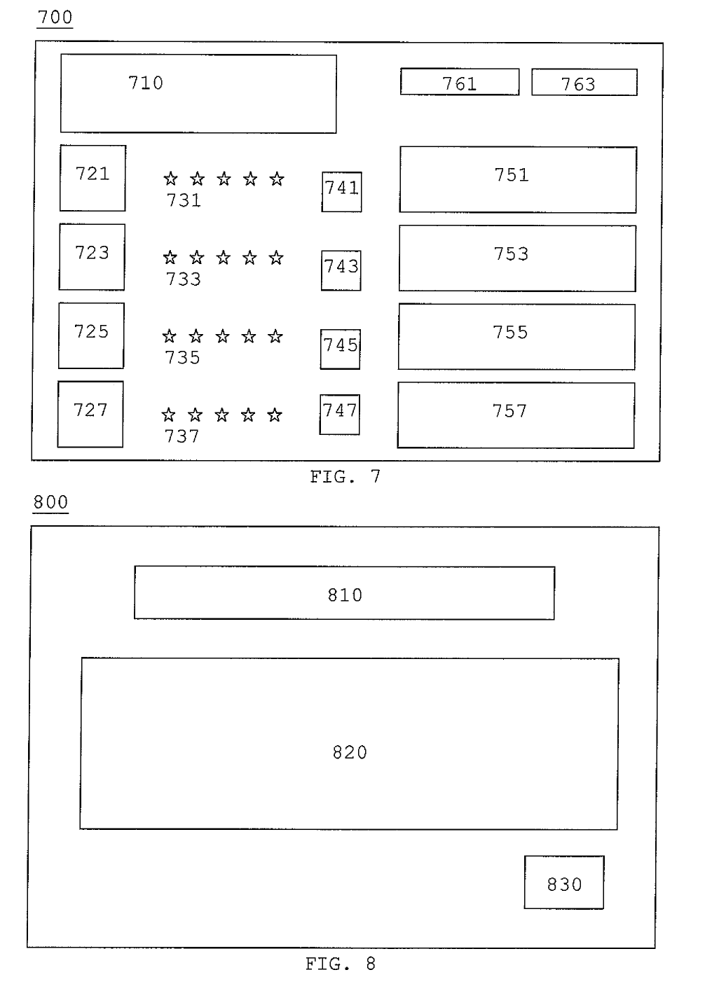

Interface 700, an exemplary additional interface depicted in FIG. 7, is preferably formed as a list of interactions 721-727 between verified users, such as a list sorted by most views, highest rating, most recent, geographic proximity, associated community, or the like. Additional subjective and/or objective evidence of communication or interaction may be included in rating fields 731-737, link fields 741-747, and text fields 541-547, or the like. Preferably, the list is sorted by most views and has no filter applied, whereby recorded interaction 721 at the top of the list is the recorded interaction having the highest number of views by users regardless of other criteria, such as the associated community, rating, geographical area, or the like. Alternatively, however, the list may be specific to one or more category or keyword, as desired, which may be entered or selected via search field 761 and/or filter field 763. Thus, users of system 100 may quickly and easily locate recorded interactions that have generated popular interest, such as for evidencing outstanding communication or interaction, or the like. Accordingly, verified users of system 100 may be motivated to do what they say at all times as a result of the positive or negative publicity provided by verified recorded interactions with other users, and associated ratings, anecdotes, comments, and/or the like.

After evaluating one or more selected target user via one or more of interfaces 300, 400, 700, and 800, user 111 may make a selection, and contact a another user, such as user 114 via system 100 to accomplish a desired objective, such as obtaining information, purchasing a service or good, developing a relationship, or the like. Specifically, a contact feature may be initiated via button 441 from interface 400, via field 341 from interface 300, or the like. The contact feature is preferably restricted to only registered users and preferably causes system 100 to automatically contact user 111, such as at a previously-provided phone number, IP address, or the like, and may require user 111 to enter a PIN number or other code or identification information, whereby the identity of user 111 is verified. System 100 then contacts user 114, or other selected target user, such as via a conferencing feature, and begins a recording process performed by host 130 that captures the interaction between users 111 and 114. User 111 may interact with user 114, such as by asking questions, arranging for service, resolving disputes, or the like. When the interaction has ended, host 130 preferably automatically stores a copy of the interaction and associates the stored interaction with the account of user 111. Accordingly, user 114 may not have access to the copy of the recorded interaction, although it is contemplated that user 114 may also have permission to view the recorded interaction, but not edit or publish the recorded interaction, whereby user 114 may compare the unedited recorded interaction with an edited version subsequently published by user 111. In a preferred embodiment, the recorded interaction is, at least initially, not accessible to any users of system 100 except user 111, and except user 114 as mentioned above, thereby avoiding accidental or unwanted publication of private information captured during the interaction, such as personal identification information, financial information, or the like. Furthermore, such default privacy of the recorded interaction preferably prevents all recorded interactions from flooding system 100.

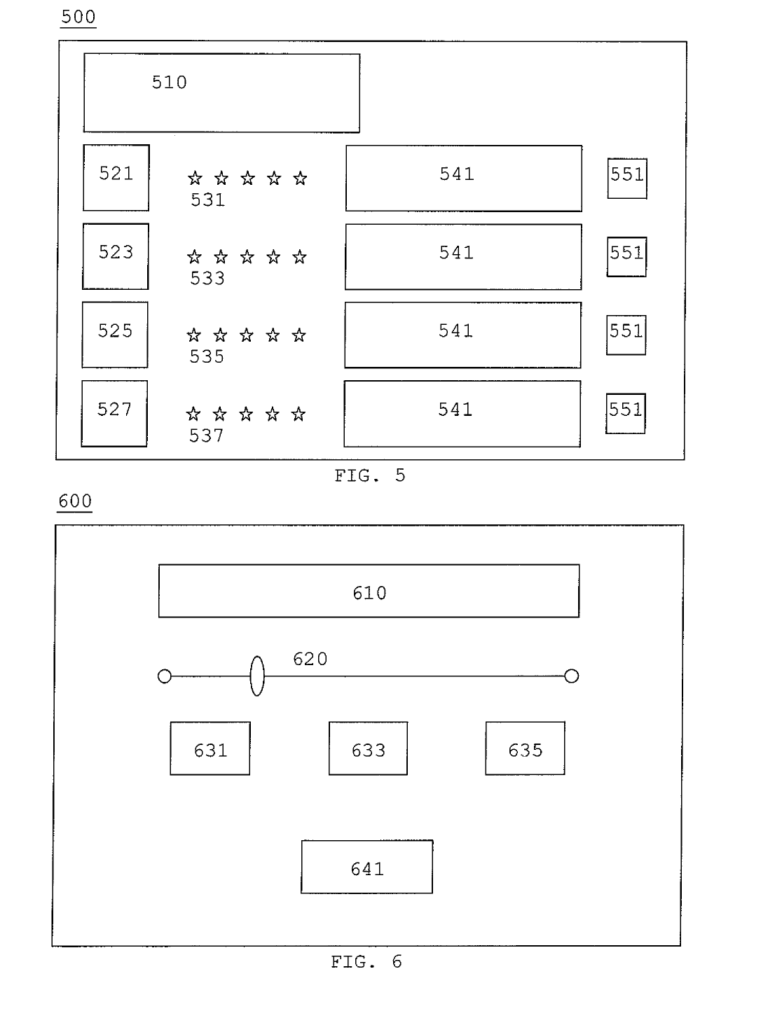

As shown in FIG. 5, user 111 may then access the recorded interaction via account management interface 500 including header 510, one or more recorded interactions 521-527 with various other users of system 100, and respective associated rating input fields 531-537, comment input fields 541-547, and publicity status fields 551-557. Specifically, user 111 may review and/or edit recorded interactions 521-527 via interface 600, discussed in greater detail below, such as by activating a link associated with a respective one of recorded interactions 521-527. User 111 may further assign a rating, such as by selecting a star associated with the selected rating in a respective one of rating input fields 531-537. Anecdotal evidence or other comments, including links to additional objective evidence recorded through system 100, may be added in a respective one of comment input fields 541-547 to supplement the rating and recorded interaction information for use by others in evaluating the nature and/or quality of communication, such as in the method described above. When user 111 is satisfied with the state of a recorded interaction, such as recorded interaction 521, and the additional rating and/or comments provided, user 111 may make recorded interaction 521 available to other users via manipulation of publicity status field 551.

As mentioned briefly above, and as shown in FIG. 6, interface 600 may be accessed by user 111 to edit a recorded interaction. Preferably, although not necessarily, system 100 limits the editing capability of user 111 to only redaction, whereby system 100 ensures that all recorded interactions stored on host 130 and accessible through system 100 accurately reflect the interaction, and are not biased, which bias may be introduced by addition of content to the recorded interaction. Specifically, interface 600 preferably includes header 610, playback bar 620 indicating a current position within a recorded interaction, and controls 631-641. Activation of control 631, such as in the form of a button, preferably starts a playback of an associated recorded interaction. Activation of control 633 preferably redacts the recorded interaction, such as by masking sensitive information via muting, adding a beep, adding a graphic, or the like, to allow selected content of the recorded interaction to remain private. For example, in an audio recording context, a beep may be used to mask the name, address, account number, financial information, or the like of user 111 and/or of user 114. Alternatively, the sound may simply be removed leaving dead space. In a video or text context, a black mark may be used to mask an image of user 111 or personal information displayed in text or graphic form, or the like. Such editing features preferably prevent substantive alteration or modification of the content or context of the recorded interaction, and a warning may optionally include a flag or other warning indicating that editing has been performed and that the content and/or context may have been altered as a result.

Control 635 may be activated to perform other selected editing functions allowed by system 100, as desired, such as cutting out unnecessary portions of the recorded interaction, such as hold periods, if desired and allowed by an operator of system 100, or the like. Activation of control 641 preferably saves a copy of the edited interaction. Such edited interaction may replace the recorded interaction, or may be stored in addition to the recorded interaction. Preferably, at least in specified circumstances, such as where portions of the recorded interaction were removed entirely, an unedited copy of the recorded interaction is maintained on host 130 for use in auditing the edited interaction to verify that the edited interaction is not biased. Such auditing my be randomly performed, and/or may be performed in response to a request, such as by the selected target user, when there is a claim that bias has been introduced to the recording through the editing process. Thus the integrity of system 100 may be ensured.

Now referring to interface 800, users of system 100, such as users 114-116, may elect to use published interactions available through system 100 as advertising or other promotion on a website or the like, whether or not maintained on host 130. Since recorded and optionally edited interactions, including recorded feedback or other comments by one user about another user, are stored on host 130, service provider 114, for example, may add feed 830, such as an RSS feed, to a webpage or other publicity tool, in addition to content or information 810 and 820 controlled by user 114. Feed 830 is preferably not editable or controlled by user 114, and may only be turned “on” or turned “off” by user 114, such as through an account management feature of system 100. In a preferred embodiment, feed 830 preferably provides access to a predetermined number of recorded (or edited) interactions published by users of system 100, with or without additional rating and/or comment information, and including interactions between two users and recorded feeback. Host 130 preferably causes selected recorded (and edited) interactions, including recorded feedback, to be displayed via feed 830. For example, host 130 may cause the most recent five published recordings to be repeatedly displayed on interface 800 via feed 830 in sequence. Alternatively, random published recordings may be displayed via feed 830, and such recordings may be displayed only on demand, if desired. Preferably, however, recordings are only made available, whether via feed 830 or via other means such as interfaces 300, 400, and/or 700, if an associated user (e.g. the user initiating the interaction or the user with whose account the recording is associated) has designated that such recording may be publicized, such as via an associated publicity status field, as discussed above.

As a further alternative, feed 830 may be operable to cause one or more recorded feedback or comment to be published thereby. For example, user 111 may record feedback for user 114 in response to a request from user 114, or simply of their own initiation. In a specific example, user 114 may activate a feedback solicitation feature of system 100 after participating in an interaction with user 111, or providing a service for user 111, or the like, whereafter system 100 may solicit feedback from user 111, such as via a telephone call, a voice over IP call, an email including a link to initiate a call, an email form for leaving feedback, or the like. In response to the solicitation from system 100, user 111 may record feedback for user 114, including in voice, text, video, or other format, which may be stored on host 130. Thus, feed 830 may provide access to such feedback recordings, either in addition to, or in place of, providing access to recorded interactions between a user 114 and another verified user of system 100.

According to an exemplary method of use, user 111 may access system 100 via a website. User 111 may then log in to host 130 by providing a user name and password combination. After verification of the user name and password combination by host 130, user 111 may then search for a selected target user. For example, if user 111 desires to locate a mechanic to repair his car, user 111 may input a keyword, such as “auto mechanic” in an entry box. User 111 may additionally, or alternatively, select a geographic proximity limitation and a rating limitation from drop-down menus. User 111 may then submit the keyword and/or other search criteria to host 130 for processing. After host 130 receives such submitted criteria, host 130 then preferably searches one or more database, or the like, to locate all verified users who meet or match the submitted criteria. Host 130 then preferably displays the names of the located verified users who meet or match the submitted criteria (target users) in a list of names, which may be sorted according to relevance, or the like, and which may be re-sorted according to a preference of user 111. User 111 may then review rating indications and information fields containing objective and/or subjective information. Specifically, an information field associated with one of the target users may include one or more link by which a recorded interaction and commentary from users of system 100 may be reviewed.

If user 111 desires to contact one of the target users listed, user 111 may activate a contact feature of system 100. If, instead, user 111 wants to investigate a selected target user further, user 111 may access a webpage associated with the selected target user. The website associated with the selected target user preferably includes a plurality of links providing access to respective recorded interactions between the selected target user and other verified users of system 100. User 111 may review one or more recorded interaction(s) in addition to one or more rating and/or comment associated with each recorded interaction. User 111 may use the recorded interactions to assess associated ratings and/or comments, in evaluating the selected service target user. If user 111 desires, based on such an evaluation, to contact the selected target user, user 111 may then activate the contact feature. Alternatively, user 111 may investigate other target users from the list via respective associated web pages, and may contact a selected one of the other target users via the contact feature.

In another exemplary method of use, user 114 may be interacting with an individual. Such interaction may occur outside system 100, including in person, and the individual may or may not be a verified user of system 100. In an effort to convince the individual to purchase goods or services from user 114, or to achieve another desired objective, user 114 may access system 100 and access one or more recorded interaction, such as one or more recorded interaction between user 114 and other verified users of system 100 and/or recorded feedback from other verified users based on an interaction with user 114. For example, user 114 may access host 130 via a cellular telephone. User 114 may enter identification information and navigate a command menu, or the like, in order to initiate a playback of one or more recorded interaction, optionally including subjective information associated therewith, such as a rating and/or comment provided via system 100 by a verified user having interacted with user 114. Alternatively, user 114 may access a website of user 114. Via such a website, user 114 may allow the individual to review one or more recorded interactions, including associated ratings and/or comments, between user 114 and other verified users of system 100. Preferably, the recorded interactions, and associated subjective information, selected for publication are selected at random, or are the most recent interactions, whereby the individual may rely on such recorded interactions and associated subjective information as representative of the type of communication or interaction provided by user 114.

By way of additional example, a first user, such as user 114, who may be a business owner or representative, a politician, or any other individual seeking to provide information about themselves, may create an account on system 100 and obtain a listing in a directory of system 100. A second user, such as user 111, who may be a customer, a voter, or another individual interested in locating a target user, may search for and locate user 114 via the directory, according to one or more selected search criteria. User 111 may contact user 114 to initiate a communication, which may optionally be recorded by system 100. User 114 may invite user 111 to leave feedback regarding an interaction with user 114, a service of user 114, an opinion or user 114, or the like. In response to such invitation, user 111 may record feedback, such as in audio, video, graphic, text, or other form, or combinations thereof via system 100, whereafter system 100 preferably associates the recorded feedback with one or more of an account associated with user 114 and an account associated with user 111. User 114 may make the recorded feedback available via a listing in the directory, a webpage or other portion of system 100 associated with user 114, a personal or commercial website associated with user 114, or the like. For example, a user may access system 100 via telephone, and, after selecting user 114, may be provided with one or more such feedback recording. Alternatively, the feedback recording may be available via and RSS feed provided on a website controlled by user 114.

As will be understood by those ordinarily skilled in the art, the various elements, features, and/or steps described above, may be accomplished by alternative means without departing from the scope of the present invention. For example, while illustrative embodiments of the present invention including web pages have been described, it should be understood that alternative webpage design elements may additionally and/or alternatively be included to accomplish the recited functionality and methodology. Furthermore, text to speech, speech to text, speech recognition, and/or recordings may be employed, whereby system 100 may be accessed via telephone interface, using number tones or speech commands to navigate menu options, receive information, initiate contact, edit recorded interactions, or the like.

Similarly, while a method of recording and evaluating communication utilizing the Internet has been described, the invention is not limited to such specific methodology; numerous additional and/or alternative method steps may be included to accomplish the functionality and features described.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A method for recording a communication between a first individual and a second individual via a communication interface comprising the steps of:
receiving a request from the first individual to initiate communication with the second individual;
initiating a communication to the first individual;
initiating a communication to the second individual; and
recording a communication between the first individual and the second individual.

2. The method of claim 1, further comprising the step of storing a copy of the recorded communication on a computer readable medium.

3. The method of claim 2, further comprising the step of associating the stored copy of the recorded communication with an account of at least one of the first individual and the second individual.

4. The method of claim 2, further comprising the step of editing the stored copy of the recorded communication.

5. The method of claim 4, wherein the stored copy of the recorded communication is an edited copy of the recorded communication.

6. The method of claim 4, wherein the step of editing comprises performing at least one authorized editing function, wherein the at least one authorized editing function is selected to prevent biasing the edited copy of the recorded communication.

7. The method of claim 2, further comprising the step of associating at least one of a rating, a comment, an anecdote, and an opinion with the stored copy of the recorded communication.

8. The method of claim 1, further comprising the step of providing a searchable directory of users.

9. The method of claim 1, further comprising the step of publicizing the recorded communication.

10. A system for recording a communication comprising:
a host operable to record at least one communication;
a storage medium controlled by the host operable to store a recording of the at least one communication; and
a communication interface operable to publicize the recording of the at least one communication stored on the storage medium.
wherein the recording of the at least one communication stored on the storage medium is associated with an account of at least one of a first user and a second user.

11. The system of claim 10, wherein said host is operable to initiate a communication with the first user, initiate a communication with the second user, and enable communication between the first user and the second user.

12. The system of claim 11, wherein said host is further operable to verify an identity of the first user.

13. The system of claim 10, wherein said communication interface comprises a directory of individuals, and wherein at least one recorded communication is accessible via said communication interface and is associated with a respective individual.

14. The system of claim 10, wherein said host comprises at least one computer accessible via an interface device.

15. The system of claim 14, wherein said interface device is selected from the group consisting of a personal computer, a phone, and a portable device.

16. The system of claim 10, wherein said host is further operable to edit at least one recorded communication stored on said storage medium.

17. The system of claim 10, further comprising a plurality of accounts, wherein each account is associated with a verified user.

18. The system of claim 10, wherein the first user is a customer and the second user is a provider of at least one of a good and a service.

19. The system of claim 10, wherein said host is operable to initiate a communication with the first user, and record a communication from the first user about the second user, and wherein said host is operable to publicize a recording of the communication from the first user about the second user.

20. The system of claim 19, wherein said host is operable to publicize the recording of the communication via at least one of a website associated with the first user, a website associated with the second user, a directory listing associated with the second user, and a telephone system operable to play the recording in response to a request.
